(19) United States
(12) Patent Application Publication
(10) Pub. No.: US 2015/0046173 A1
(43) Pub. Date: Feb. 12, 2015

(54) METHOD AND SYSTEM FOR REQUESTING PRIOR AUTHORIZATION FOR MEDICAL PRODUCTS AND SERVICES

(71) Applicant: Agadia Systems Inc., Parsippany, NJ (US)

(72) Inventors: Scott Louis Furletti, Northvale, NJ (US); Scot Alan Lovejoy, Nutley, NJ (US); Srikanth V. Swarna, Randolph, NJ (US)

(73) Assignee: Agadia Systems Inc., Parsippany, NJ (US)

(21) Appl. No.: 13/963,608

(22) Filed: Aug. 9, 2013

(51) Int. Cl. G06Q 50/22

(52) U.S. Cl. CPC G06Q 50/22; G06Q 40/08
USPC 705/2

(57) ABSTRACT

A system and method for requesting prior authorization for a medical product and/or service includes a processor providing a user interface accessible over a network and via which to receive user input of information concerning the product and/or service, the intended recipient thereof, and the prescriber thereof. The user interface is accessible using each of a plurality of user profiles, including two or more of the prescriber, user, and provider. Login information is not required for the request generation, a recipient health plan identification being used instead. Different sequences are provided by the processor depending on the user profile used for generating the request. Request status is provided based on input of a code generated for the request and without requiring login information. The system is configured to generate and transmit to the prescriber a communication regarding the request where the request is initiated using a recipient profile.

### FIELD OF THE INVENTION

The present invention relates to a method and a system for requesting prior authorization for medical products and/or services, e.g., from an entity that pays for at least a portion of the costs of the requested product/service when prior authorization has been granted. This entity is typically an insurance company that sponsors a health plan for a recipient of the product/service, i.e., the patient.

### BACKGROUND INFORMATION

Many patients rely on health insurance for subsidizing the costs of medical products and services. Both private insurance companies and public health insurance programs such as Medicare require that their insured patients seek prior authorization (PA) for certain types of products/services. If the patient obtains those products/services without first obtaining PA, the insurer may refuse to cover the cost. PA generally involves a review of the circumstances surrounding the request including, e.g., the patient's overall medical history, the specific medical conditions that purportedly gave rise to the request, and the identity of the doctor, nurse or other medical professional recommending the product/service (the prescriber). Conventional PA procedures are time consuming and typically require numerous back-and-forth communication between the prescriber, the insurance company (the plan sponsor), a third-party benefit manager (BM) that handles PA requests on behalf of the plan sponsor, and/or the entity providing the product/service (e.g., the prescriber, another doctor, a hospital, a laboratory or a pharmacy). This communication may include telephone conversations and/or fax transmissions, in order to obtain enough information to process the request.

To reduce the amount of back-and-forth communication, Internet-based portals have been developed which allow doctors to initiate PA requests on behalf of their patients, by submitting the requests to a benefit providing entity (e.g., to the plan sponsor or the BM). To date, such portals for initiating the requests, have been limited to use by the prescribing doctors. Additionally, usage of these portals has not been widely adopted because each portal is limited to servicing a specific type of request. For example, dedicated portals may be set up for each of prescriptions, blood work, radiology, and surgery, and each portal may require a separate registration, e.g., a user ID and password. Further, doctors generally participate in a plurality of insurance plans, each with its own set of portals. Therefore, regular use of conventional portals may require managing a long list of registration information.

### BRIEF DESCRIPTION OF THE DRAWINGS

FIG. 1 is a block diagram of a system for requesting prior authorization for medical products and services, according to an example embodiment of the present invention.

FIG. 2 is a flowchart that shows a method for requesting prior authorization for medical products and services, according to an example embodiment of the present invention.

FIGS. 3 to 5 show a user interface by which a user inputs basic information for initiating a PA request, according to an example embodiment of the present invention.

FIG. 6 shows a user interface by which a user inputs insurance information pertaining to a patient for initiating a PA request, according to an example embodiment of the present invention.

FIG. 7 shows a user interface by which a user inputs the user's contact information, according to an example embodiment of the present invention.

FIGS. 8 and 9 show a user interface by which a user identifies a prescription drug in connection with a PA request for the identified drug, according to an example embodiment of the present invention.

FIGS. 10 and 11 show a user interface by which a user identifies a prescription drug, together with drug treatment parameters, in connection with a PA request for the identified drug, according to an example embodiment of the present invention.

FIGS. 12 and 13 show a user interface by which a user identifies a medical service in connection with a PA request for the identified service, according to an example embodiment of the present invention.

FIGS. 14 and 15 show a user interface by which a user identifies a prescriber in connection with a PA request, according to an example embodiment of the present invention.

FIGS. 16 and 17 show a user interface by which a user identifies a provider in connection with a PA request, according to an example embodiment of the present invention.

FIG. 18 shows a graphical confirmation of a PA request successfully initiated by a patient-user, according to an example embodiment of the present invention.

FIG. 19 shows a user interface by which a prescriber-user initiates a PA request, according to an example embodiment of the present invention.

FIG. 20 shows a user interface by which a prescriber-user inputs answers to a medical necessity questionnaire, according to an example embodiment of the present invention.

FIG. 21 shows a user interface by which a prescriber-user attaches supporting documents for a medical necessity questionnaire, according to an example embodiment of the present invention.

FIG. 22 shows a graphical confirmation of a PA request successfully initiated by a prescriber-user according to an example embodiment of the present invention.

FIGS. 23 and 24 show a user interface by which a user inputs information for requesting the status of a previously initiated PA request according to an example embodiment of the present invention.

### SUMMARY

Example embodiments of the present invention provide a system and method for requesting prior authorization for medical products and/or services. In a preferred embodiment, access to medical products and services is provided through a central computer to facilitate the initiation of PA requests by various categories of users. According o example embodiments, one user category is the patient itself. Allowing the patient to initiate PA requests on the patient's own behalf allows for reduction of the amount of communication between different parties involved in initiating and processing the request, e.g., including the prescriber and the provider. Thus, according to example embodiments, the system includes features that allow the patient-user to expedite the approval process by providing basic information concerning the patient and/or the product or service being requested.

According to example embodiments, the system is configured for a user to identify the user's user category by selecting a profile from a list of stored user profiles. According to example embodiments, a process for initiating the PA request differs depending on which profile is selected. In particular, the process may involve requesting and outputting different information based on the selected profile. Advantageously, this allows the system to tailor a user interface to the needs of different types of users, in particular, to the needs of patient users.

According to example embodiments, a system and method for initiating a PA request allows a user to initiate the request on behalf of a patient without requiring the user to log into the system, provided the user can supply health insurance information associated with the patient. In an example embodiment, this health insurance information includes the patient's health plan member ID. This is especially useful when the user is the patient itself because patients are not traditionally registered users of PA request systems.

According to example embodiments, a system and method for initiating a PA request involve a user interface, which is accessible through any of a plurality of Internet addresses. In a preferred example embodiment, each Internet address is associated with a respective health insurance plan sponsor. A database is selected as a function of the Internet address by which the user interface was accessed. Criteria for determining whether to grant the PA request is obtained from the selected database based on information about the patient, e.g., the patient's health plan member ID. Advantageously, since the Internet address identifies the patient's plan sponsor, it also identifies which database is the relevant database from which to obtain the criteria. Therefore, a system according to an example embodiment of the present invention allows for non-unique member IDs between different databases, where the health plan member IDs are used for initiating PA requests, and the system need not check for uniqueness of member IDs. This is useful because plan sponsors typically generate member IDs independently without consideration of how other plan sponsors generating member IDs. This is further useful because, as noted above, this allows for the user to access the system for initiating a PA request using the health plan member ID, without requiring the user to have separate log-in information for accessing the PA request system.

According to example embodiments, a system and method for initiating a PA request involve providing a user with an identifier code generated in association with the PA request, the system being configured to provide a status of the PA request in response to user input of the identifier code. Advantageously, this allows any user with knowledge of the code to obtain the status without having to log into the system. Therefore, the user need not be registered with the system, and the system need not confirm the user's identity. According to one example embodiment, the system always requires the code for obtaining the status in order to allow the system to be fully functional without requiring log-in.

According to example embodiments, a system and a method for processing a PA request are configured to generate a medical necessity questionnaire for transmission to a prescriber-user or a provider-user. The questionnaire can be an interactive form, and, according to an example embodiment, the user is given an option to answer the questionnaire electronically by filling in the answers through a user interface, and an option to print the questionnaire onto paper for handwriting the answers. Advantageously, this allows the user to provide the answers at a convenient time, allowing the request to be initiated without requiring immediate answers. It also reduces paperwork and the user does not have to wait for a fax or paper form to arrive.

According to example embodiments, a system and method for initiating a PA request require the user to identify a prescriber irrespective of whether the prescriber is also the user initiating the PA request. This is useful to allow the system to be used without requiring log-in, such that the system therefore does not obtain login information by which to be able identify the user-prescriber.

According to example embodiments, a PA request system and method provide for associating an initiated PA request with a completed medical necessity questionnaire that includes answers to questions pertaining to the intended recipient of the medical product and/or service for which approval is being sought. The prior authorization request is associated with the completed questionnaire using a previously generated identifier code. This is useful, for example, where the prescriber is not the one who initiated the PA request. In such situations, the prescriber can submit the completed questionnaire separately and have the completed questionnaire associated with the PA request by inputting the identifier code in connection with the submission. This is also useful where the prescriber initiates a PA request but chooses to complete the questionnaire at a later point in time.

### DETAILED DESCRIPTION

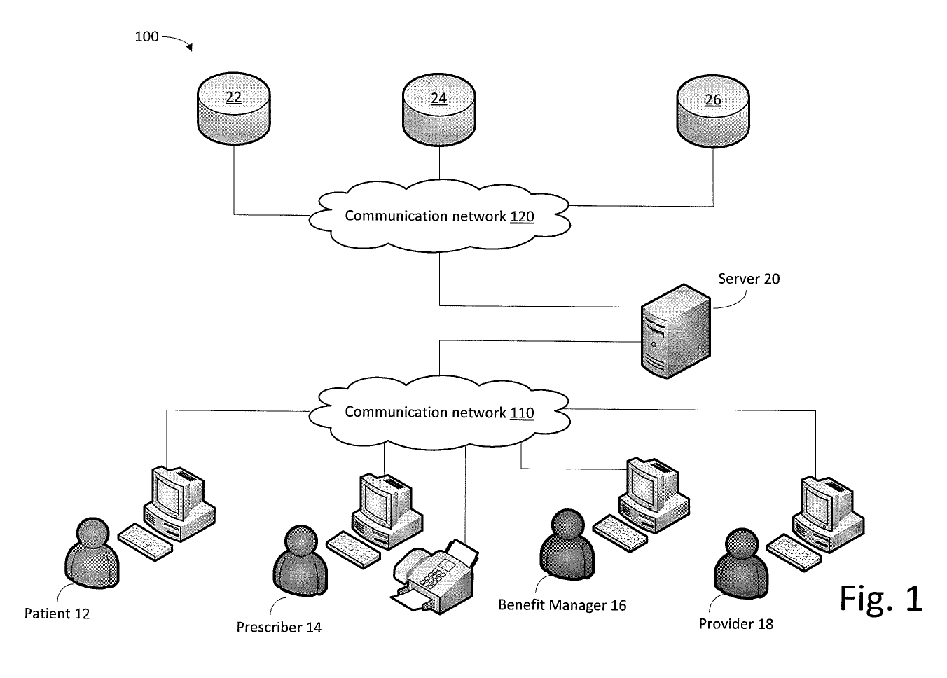

FIG. 1 shows an example system 100 for requesting prior authorization for medical products and services according to an example embodiment of the present invention. The system 100 may include a plurality of users, e.g., including a patient 12, a prescriber 14, a benefit manager (BM) 16 and a provider 18, e.g., using terminals to access a central computer, e.g. a server 20, through a communication network 110, such as the Internet. The server 20 may be accessed using different types of computer devices, including desktops, laptops, mobile phones and/or pharmacy kiosks. Each user computer may include a display and an input apparatus such as a keyboard or keypad. In one embodiment, users are able to access the server 20 via a network address, e.g., a uniform resource locator (URL) of a web page hosted by the server 20.

According to an example embodiment the server 20 includes a processor and a non-transitory, hardware-implemented computer-readable medium storing program code executable by the processor to perform a method for requesting PA according to the present invention. For example, according to an example embodiment, the program code includes instructions that provide a user interface (UI), which may be graphical and/or text-based. The UI may be accessed by any of the users 12 to 18. In an example embodiment, the UI is accessed through one of a plurality of web pages. Each web page is a portal through which the UI may be provided to any of the users 12 to 18. Each web page may be associated with a respective plan sponsor. For example, according to an example embodiment, to access the portal, a user can input a URL of the form http://SponsorName.UserInterface.com. Other suitable URL formats exist, such as http://UserInterface.com/SponsorName. Advantageously, this arrangement allows users associated with different plan sponsors to access the same UI, without requiring the users to register with the UI, e.g., by setting up a user account at the server 20. In an example embodiment, the URL redirects the user's web browser to a secured web page, e.g., to a web page that uses the Hypertext Transfer Protocol Secure (HTTPS) protocol to display the UI.

According to an example embodiment, the server 20 is configured for accessing a plurality of databases 22, 24 and 26 via the network 110 or via a second communication network 120, e.g., in communication with the network 110. In an example embodiment, the network 120 includes a private network or a virtual private network accessed using Internet Protocol (IP) addresses that are not included in the public IP address space. According to an alternative example embodiment, the server 20 is registered with the databases 22 to 26 and the databases 22 to 26 are accessible by supplying registration information through a public IP address.

For example, according to an example embodiment, the databases 22 to 26 are operated by respective plan sponsors or benefits managers that control the contents of the respective databases. According to an example embodiment, the databases 22 to 26 store criteria used for determining whether a PA request should be granted or denied. Different criteria can be associated with different respective products and services. According to an example embodiment, the server 20 is configured to search, using the name or identifier of a product/service that is the subject of a PA request, any of the databases 22 to 26 for criteria pertaining to the product/service. The criteria can also be plan-specific in that the plan sponsor may offer a variety of plans that differ in the extent to which certain products and services are covered. According to an example embodiment, based on the patient's member ID, the server 20 determines which plan the patient is a member of, to obtain the criteria relevant to that plan. The databases 22 to 26 may be used for other purposes specified by the plan sponsor. For example, a database may store personal information pertaining to insured patients, plan benefit information such as co-payment costs, and a list of participating providers. According to an example, the server 20 is restricted from accessing such additional information, e.g., access to the databases by the server 20 may be limited to, for example, only the stored criteria.

According to an example embodiment, patients are identified in the database of their respective plan sponsors according to respective member IDs, for example, where each plan sponsor generates member IDs independently of member ID generation by the other plan sponsors, and without consideration of the member IDs generated by the other plan sponsors. Therefore, it is possible that the same member ID can refer to different patients, the ID having been generated by more than one of the plan sponsors. However, according to an example embodiment, the use of the different URLs allows the server 20 to determine which plan sponsor the patient is associated with, and therefore from which database 22 to 26 to obtain the criteria, and therefore uniqueness of the member IDs is not a requirement between the databases 22 to 26.

According to an example embodiment, the server 20 is configured to transmit results of PA requests (e.g., a decision to grant or deny, along with an explanation for the decision) to one or more users. In an example embodiment, the server 20 sends a result through a fax to a prescriber and/or a provider. For example, according to an example embodiment, the fax can be sent over the Internet, e.g., by transmitting the result as an image file to a fax server that hosts a virtual fax number for the prescriber/provider. Alternatively, the fax can be sent over traditional telephone lines, i.e., via a direct dial-up connection to a fax machine. According to an example embodiment, the server 20 is configured to generate a letter containing the result, which letter is printed and physically mailed to the patient. According to an example embodiment, the server is configured to transmit the result for instantaneous display on the user's web browser. According to an example embodiment, the server is configured to additionally or alternatively transmit the result for subsequent display at a time of the user's choosing, e.g., in an email or a text message.

As explained below in connection with a method for requesting PA, according to an example embodiment, the system 100 allows various categories of users to initiate a PA request without requiring the users to log in. Advantageously, this allows patients (who are not necessarily registered with the server 20) to initiate a PA request using information to which they normally have access and which is usually readily available to the patients, e.g., their health insurance member ID. Unlike the doctor users of conventional portals, patients are not members of the medical profession and therefore it should not be expected that they be required to register with the system, even if patients are sometimes registered with the systems of their respective plan sponsors, e.g., a plan sponsor system that allows the patients to access their plan information. Thus, while patients may be registered, e.g., with the databases 22 to 26, there is no need to register with the server 20, at which the PA request is processed.

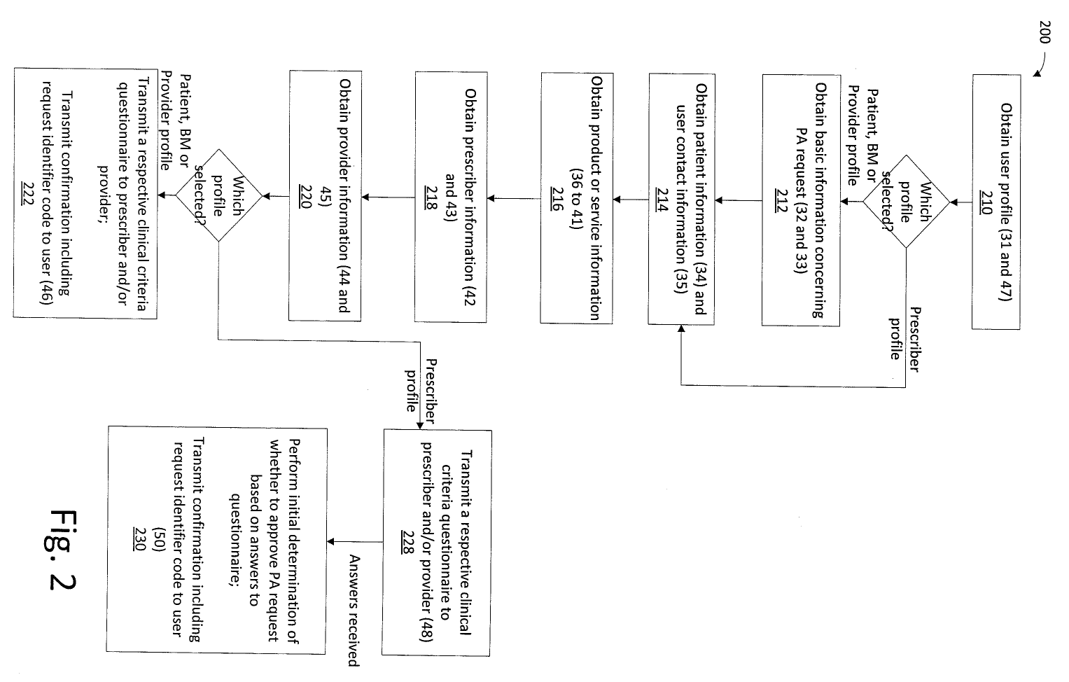

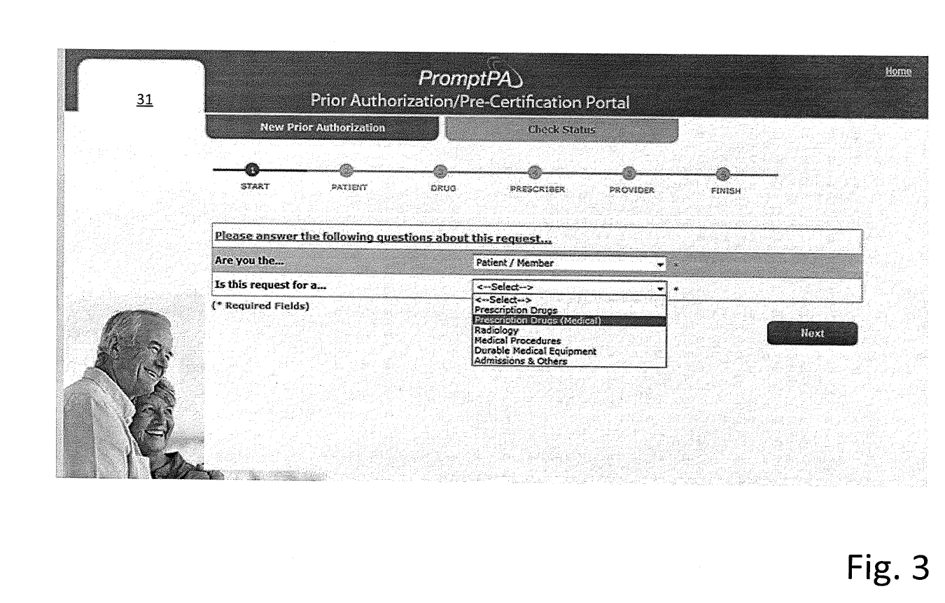

FIG. 2 is a flowchart of a method 200 for requesting PA according to an example embodiment of the present invention. The method 200 will be described in connection with FIGS. 3 to 23 which show example graphical user interface (GUI) screens. The parentheticals in the FIG. 2 refer to the screenshot numbers of FIGS. 3 to 23. According to an example embodiment, the method 200 can be performed using the system 100.

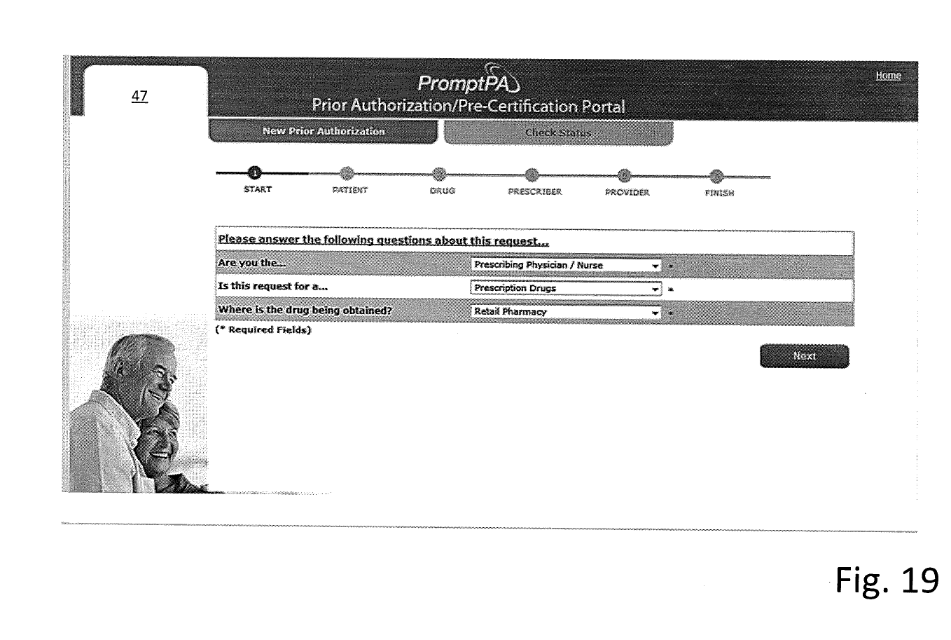

At step 210, a user profile is obtained, e.g., by the server 20, along with basic information for initiating a PA request. In an example embodiment, a user can self-identify the category to which the user belongs, by selecting a user profile from a list of stored user profiles, including, for example, a patient profile, a prescriber profile, a BM profile and a provider profile. According to an example embodiment, the server 20 is configured to output different information to, or request different information from, the user depending on which profile the user selected. FIG. 3 shows a UI 31 in which the user has selected the patient profile, thereby asserting that the user is a member of an insurance plan, the sponsor of which is a participant in a system according to the present invention. Although the UI allows the user to identify the user as any category of user, e.g., a prescriber as shown in FIG. 19, according to an example embodiment, the UI is configured to subsequently authenticate the user to confirm that the user is authorized to initiate the PA request on behalf of the patient. For example, as discussed later, according to an example embodiment, the UI requires that the user provide health insurance information of the patient as a condition for initiating the PA request.

At step 212, basic information concerning the PA request is obtained. FIGS. 3 to 5 show example embodiments of a UI 31/32/33 by which a user inputs basic information for initiating the PA request. FIG. 3 shows an embodiment where the user is requested to identify the type of product or service that is the subject of the request. Example product/service types include prescription drugs, prescription drugs pursuant to a course of medical treatment, radiology, general medical procedures, durable medical equipment (e.g., wheelchairs, nebulizers or blood sugar monitors), and hospital admissions (e.g., in-patient surgery).

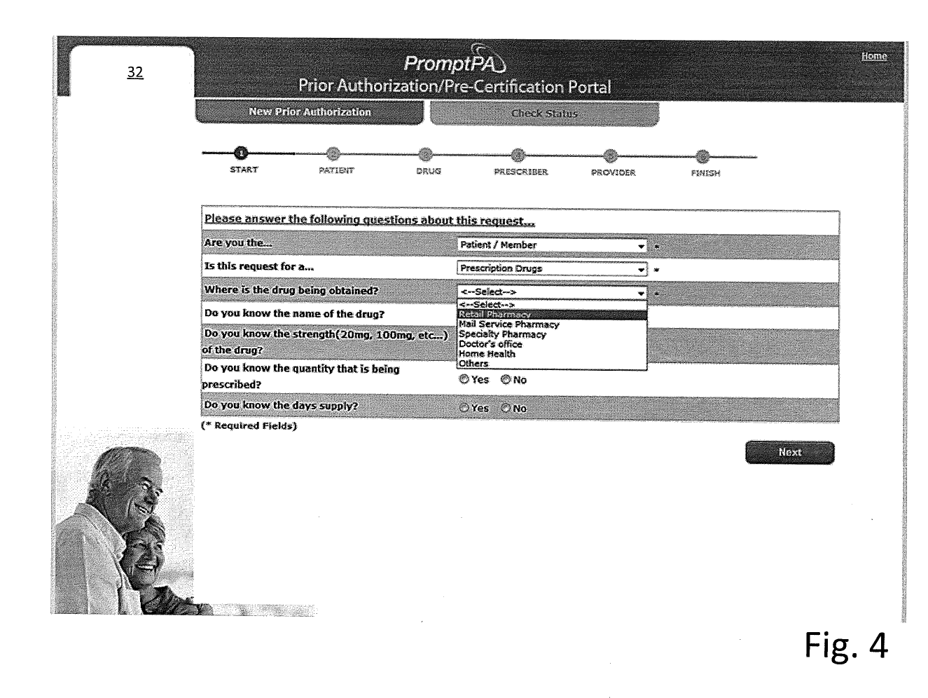

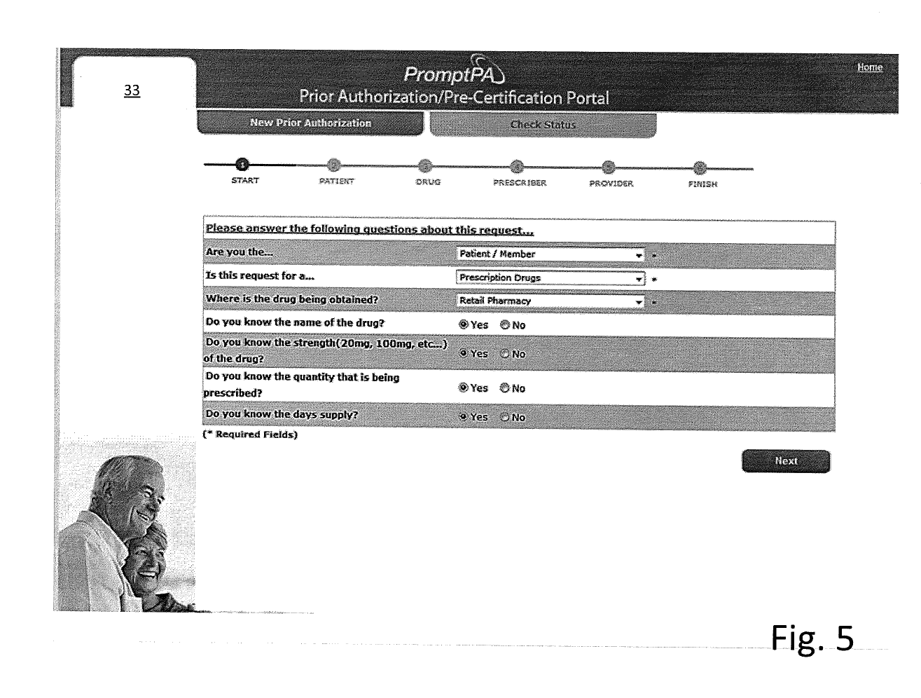

In FIG. 4, the user has specified a prescription drug request, and the UI 32 requests information concerning where the drug is being obtained (e.g., at a retail pharmacy, a mail service pharmacy, a specialty pharmacy, a doctor's office, or through a home health care service). In FIG. 5 shows an embodiment where the UI 33 requests whether the user knows the name of the drug, the strength of the drug (e.g., in milligrams), the quantity prescribed, and the number of days supplied. As indicated by the asterisked fields in FIGS. 3 to 5, according to an example embodiment, the basic information includes information that is required in order to continue processing the PA request. This prevents the user from having to provide detailed information (e.g., patient insurance information) when the user is unable to complete the PA request for lack of even the basic information. In other words, according to an example embodiment, the system first obtains basic information concerning information the user will be able to provide, so that the user does not work through a part of a process of initiating a PA, only to then realize at a later stage that the user does not have the information required to complete the PA request. This initial check can therefore save the user much unproductive time and effort.

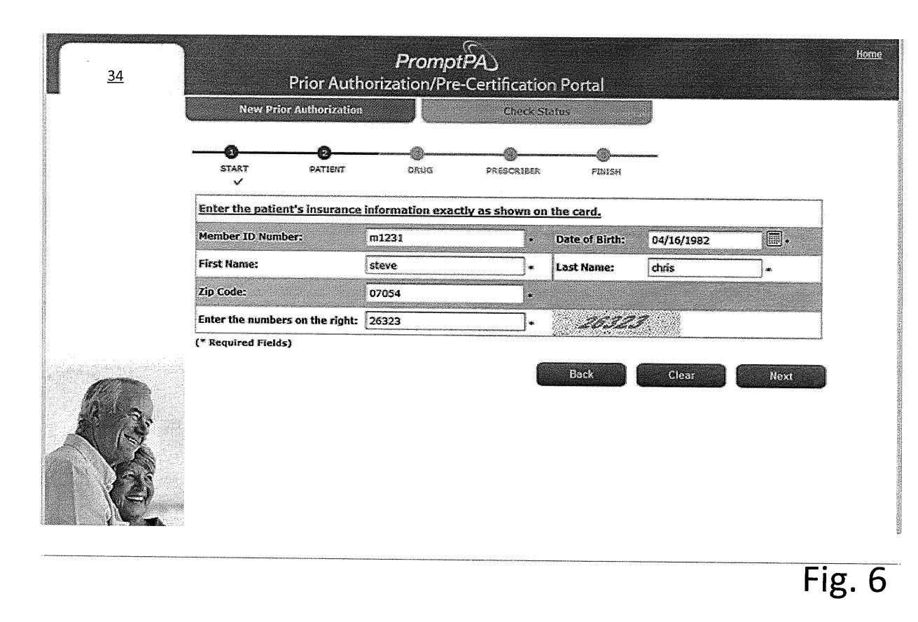

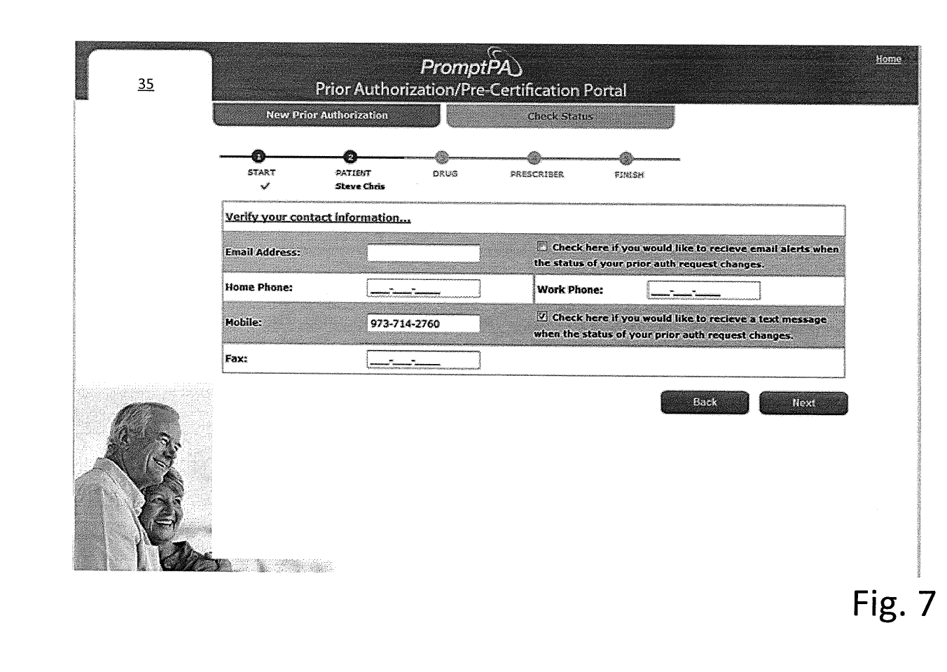

Referring back to FIG. 2, according to an example embodiment, the server 20 is configured to, at step 214, obtain information concerning the patient who is the subject of the PA request, i.e., the recipient of the product/service. For example, in an example embodiment, a UI 34 is output via which to receive input of the patient's insurance information as shown in FIG. 6. For example, the insurance information includes what is typically printed on the patient's insurance card, e.g., a member ID, the patient's first and last name, or the patient's mailing address. The insurance information can also include information that is not typically printed on an insurance card, but which would be known to the patient or to a user authorized to act on behalf of the patient. For example, the UI can be configured to receiving input of the patient's date of birth (which would be known, for example, to the patient's prescriber or provider) as a security measure in order to confirm that the user is authorized to initiate the PA request on the patient's behalf. According to an example embodiment, the UI is also configured to perform a challenge-response test (e.g., a series of alphanumeric characters that the user must input) in order to determine whether the user is human or a machine. For example, if the user is determined to be human and has filled out the required fields shown in FIG. 6, the method is adapted for proceeding to the UI 35 in FIG. 7.

In FIG. 7, the UI 35 is shown to include fields for input of the user's contact information, which can include, for example, an email address, one or more telephone numbers, a fax number, and options to receive email alerts or text messages when the status of the PA request changes.

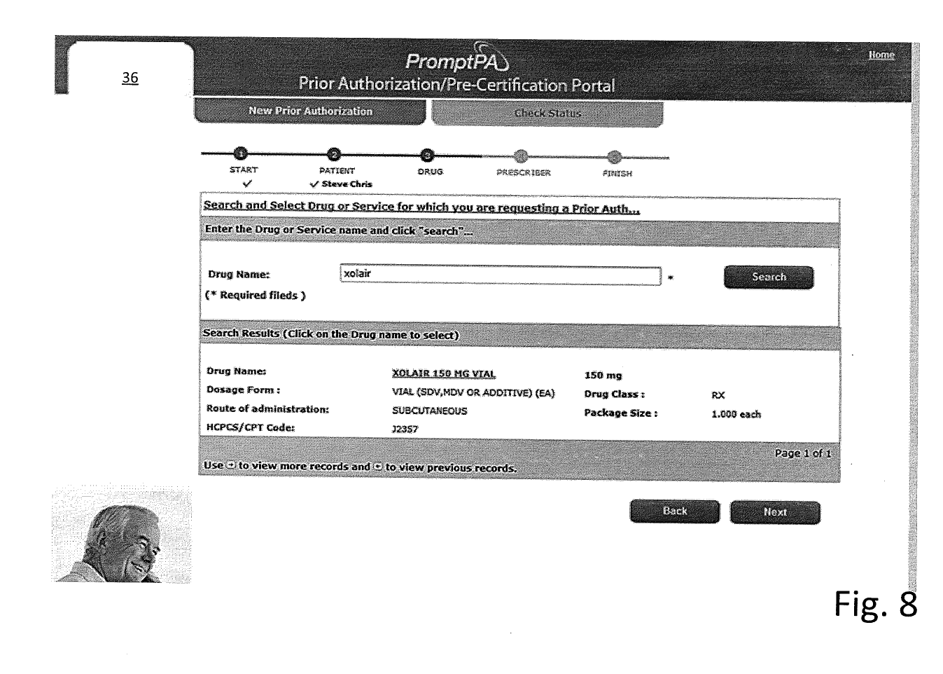

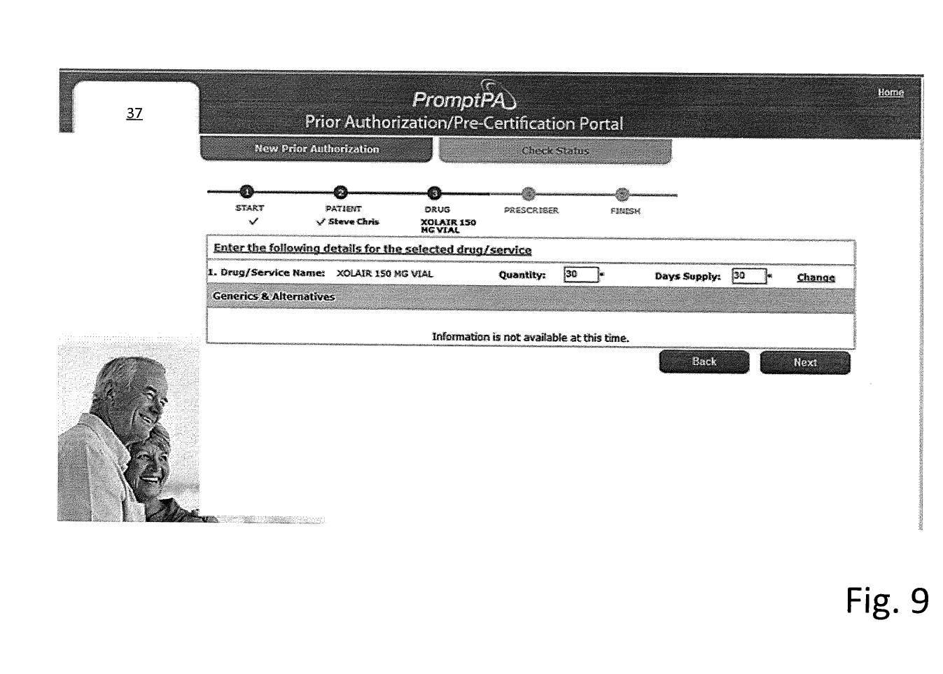

According to an example embodiment, at step 216, the server 20 obtains information concerning the product or service. For example, if the user indicated that the request is for a prescription drug, the UI 36, according to an example, includes fields for receipt of input of the name of the drug, and the system searches a drug database for the drug name, as shown in FIG. 8. Next, according to an example embodiment and as shown in FIG. 9, the UI 37 is provided for receipt of a dosage quantity (e.g., 30 doses) and a supply quantity (e.g., 30 days), both of which may have been communicated to the user by the prescriber.

In an example embodiment, if generic or alternative versions of the requested drug/service are available, the system is configured to display these alternatives and provide the user with an option to request an alternative.

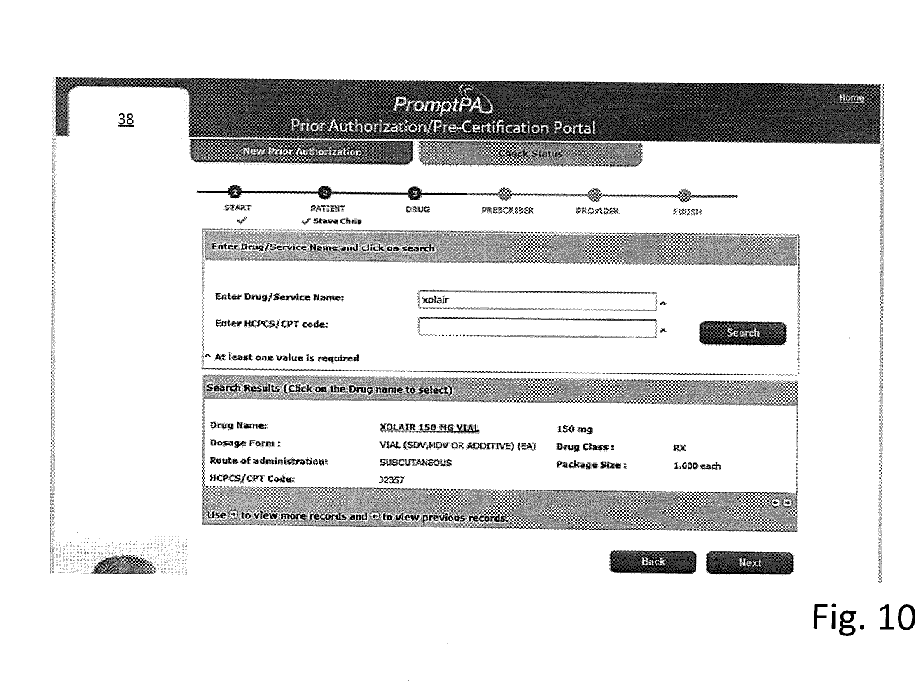

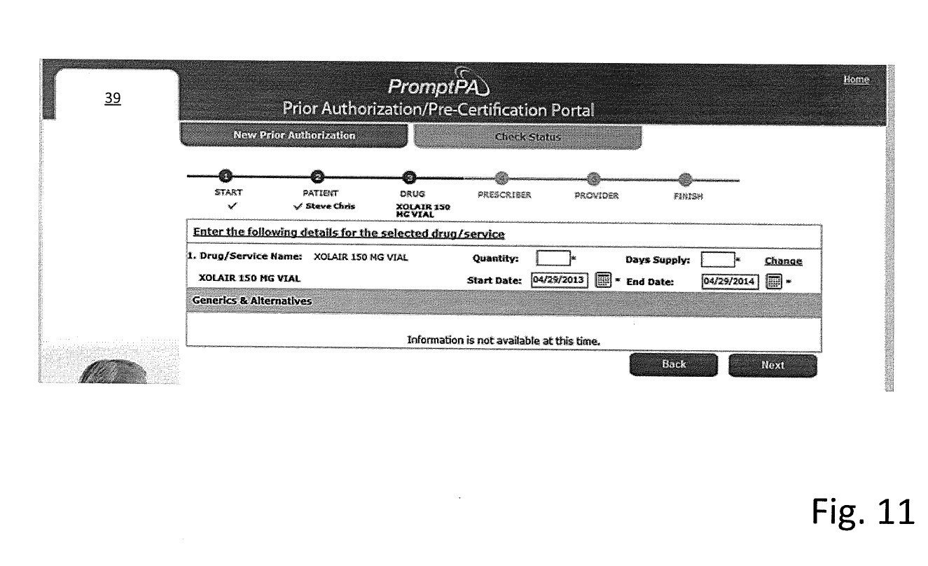

FIGS. 10 and 11 show example embodiments of a UI 38/39 in which the user indicated that the request is for a prescription drug, in connection with a course of medical treatment. As shown in FIG. 10, the UI 38 may search for a drug/service by name. Alternatively or additionally, the user can search for a drug or service using an identifier such as a Healthcare Common Procedure Coding System (HCPCS) code or a Current Procedural Terminology (CPT) code as a search parameter. In FIG. 11, the UI 39 is shown to include fields for receipt of input of treatment parameters. For example, if the user is requesting a drug, the treatment parameters can include a start date and an end date for the treatment, in addition to the dosage quantity and supply quantity.

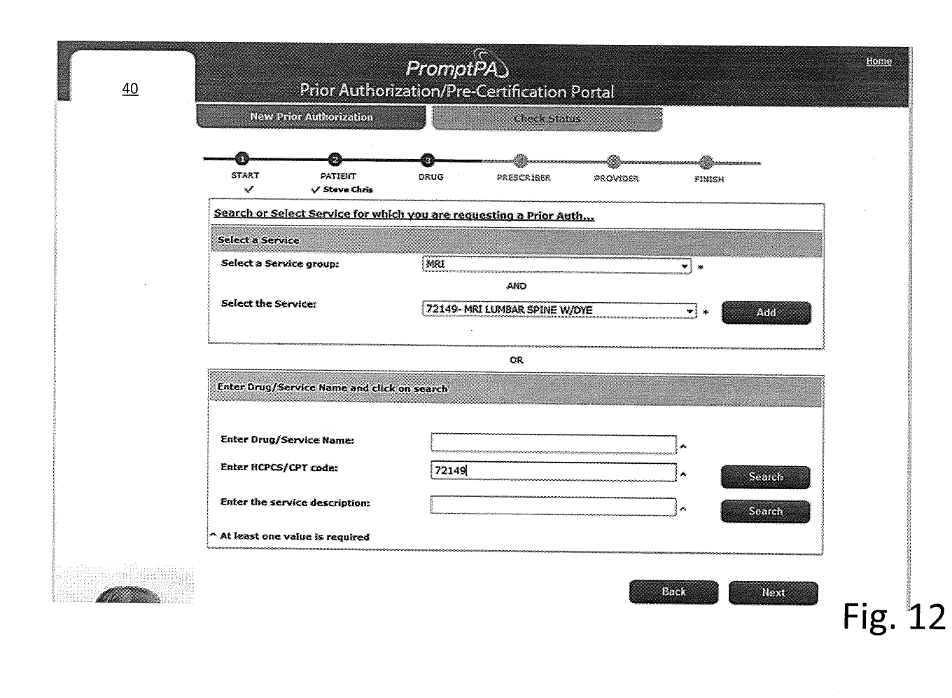

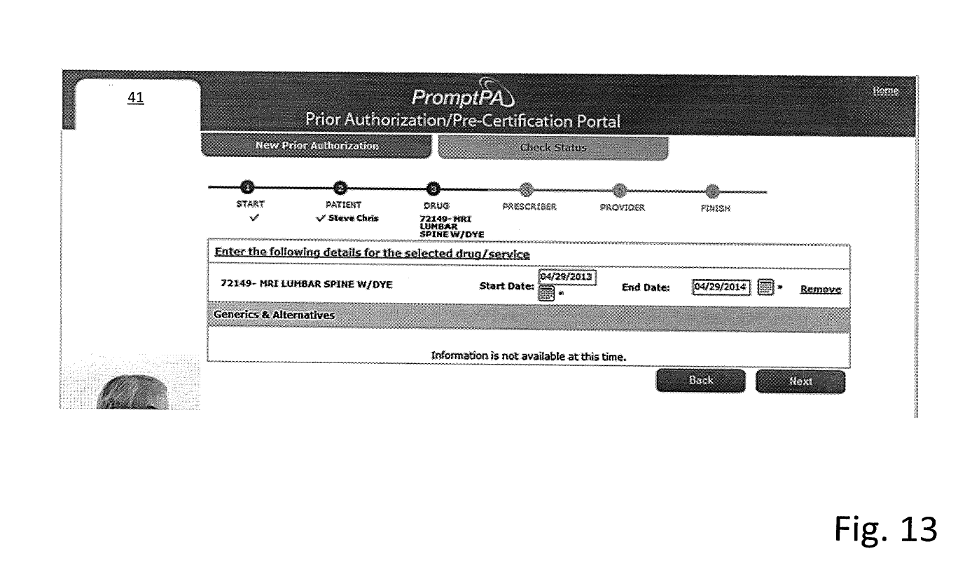

FIGS. 12 and 13 show example embodiments of a UI 40/41 in which the user indicated that the request is for a medical service, in connection with a course of medical treatment. For example, the UI 40 is shown to include fields for receipt of input of information concerning a type of service, e.g., magnetic resonance imaging (MRI). After identifying the service type, the user may be requested to further define the service, e.g., MRI of the lumbar spine with dye. According to en example embodiment, these service types and/or specific services are presented in the form of a drop-down list from which one respective selection can be selected. Alternatively or additionally, according to an example embodiment, the UI 40 allows the user to search for the service using a name of the service, an HCPCS/CPT code, or a text description as search parameters. Similar to the UI 39, according to an example embodiment, the UI 41 includes fields for input of treatment parameters such as a start date and an end date for the treatment.

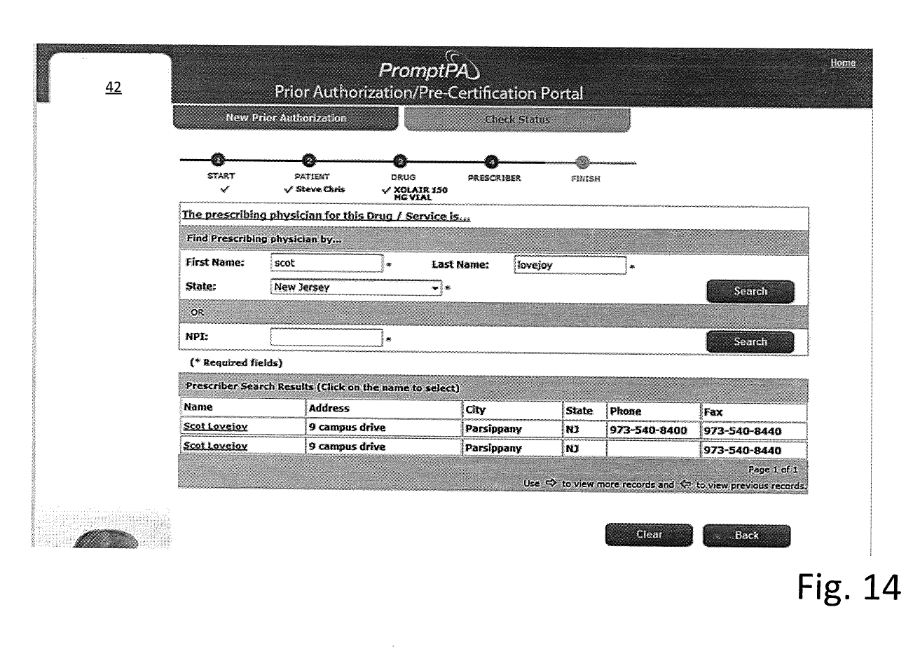

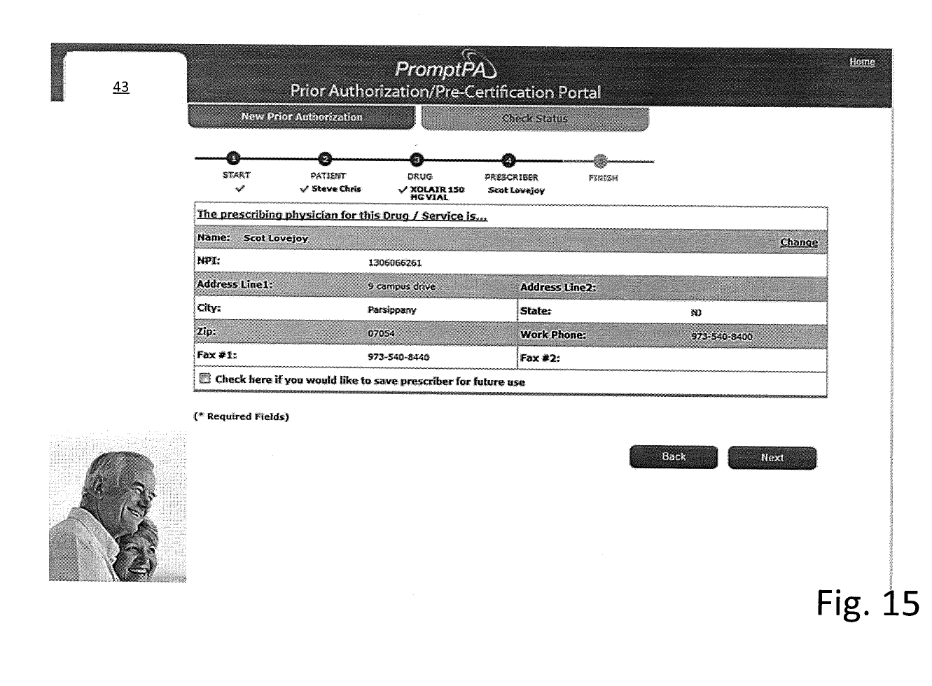

According to an example embodiment, at step 218, the server 20 is configured to obtain information concerning the prescriber of the product or service. FIGS. 14 and 15 show an example UI 42/43 by which the user identifies a prescriber in connection with a PA request. Because, according to example embodiments of the present invention, the system 100 does not require the user to log in, the system 100 does not confirm the identity of the user. Therefore, in contrast to conventional portal systems, in which the user is a registered doctor, a system according to the present invention may require that the user identify the prescriber, irrespective of whether the prescriber is also the user. As shown in FIG. 14, according to an example embodiment, the UI 42 allows the user to search for the prescriber using the prescribers name, location, or National Provider Identifier (NPI) as search parameters. As shown in FIG. 15, according to an example embodiment, the UI 43 displays detailed information for an identified prescriber and provides an option to save the prescriber for future use. For example, the server 20 may associate the patient's member ID with the prescriber so that a user initiating a subsequent PA request for the same patient is able to select the prescriber without performing a search.

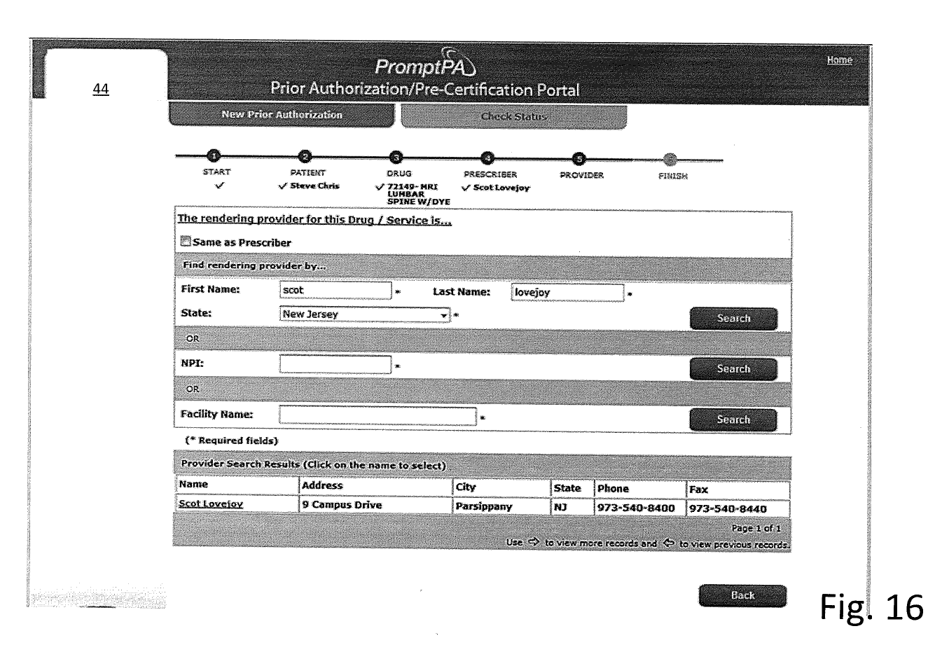

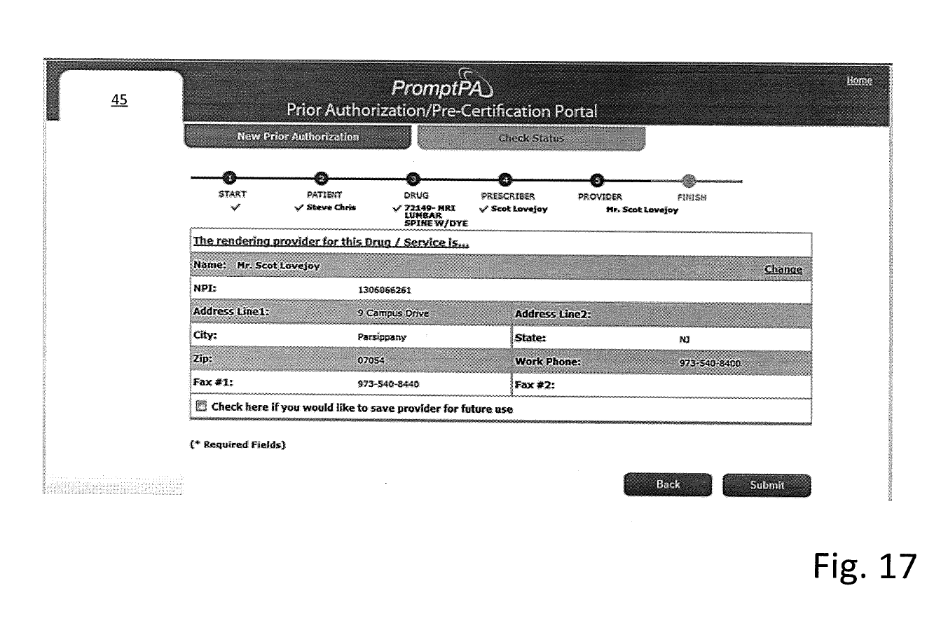

According to an example embodiment, at step 220, the server 20 is configured to obtain information concerning the provider of the product or service. FIGS. 16 and 17 show example UI 44/45 by which the user identifies a provider in connection with a PA request. The UI 44 allows the user to search for the provider, e.g., using the same parameters as the prescriber search in FIG. 14. As an alternative to searching for the prescriber, the UI 44 allows the user to indicate whether the prescriber and the provider are the same entity. The UI 44 displays detailed information for an identified provider and includes an option to save the provider identification for future use. For example, similar to the saving of the prescriber, the server 20 may associate the patient's member ID with the provider.

According to an example embodiment, where a user is associated with a user type profile other than the prescriber profile, the system is configured to, at step 222, transmit a medical necessity questionnaire to the prescriber identified at step 216. For example, the questionnaire includes questions pertaining to the patient (e.g., questions about the patient's medical history) and is generated based on criteria relevant to the requested product/service, which criteria is obtained from the database 22 to 26 associated with the patient's plan sponsor. According to an example embodiment, the questionnaire is pre-populated, e.g., partially, by auto-fill-in of answer fields with information provided by the user earlier in the process, e.g., the drug/service information provided during step 216 and/or the provider information provided during step 218. As explained previously, the database can be selected based on the URL used to access the portal.

In an example embodiment, a questionnaire is transmitted to the provider in addition to, or as an alternative to, transmission to the prescriber. Questionnaires generated for prescribers may be the same as or different from questionnaires generated for providers. For example, if the provider is also a doctor, then the provider can be expected to be able to answer the same types of questions as those which would be posed to a prescriber. However, if the provider is a pharmacist, the questions may involve a lower level of medical expertise or less intimate knowledge of the patient's medical history, than the prescriber.

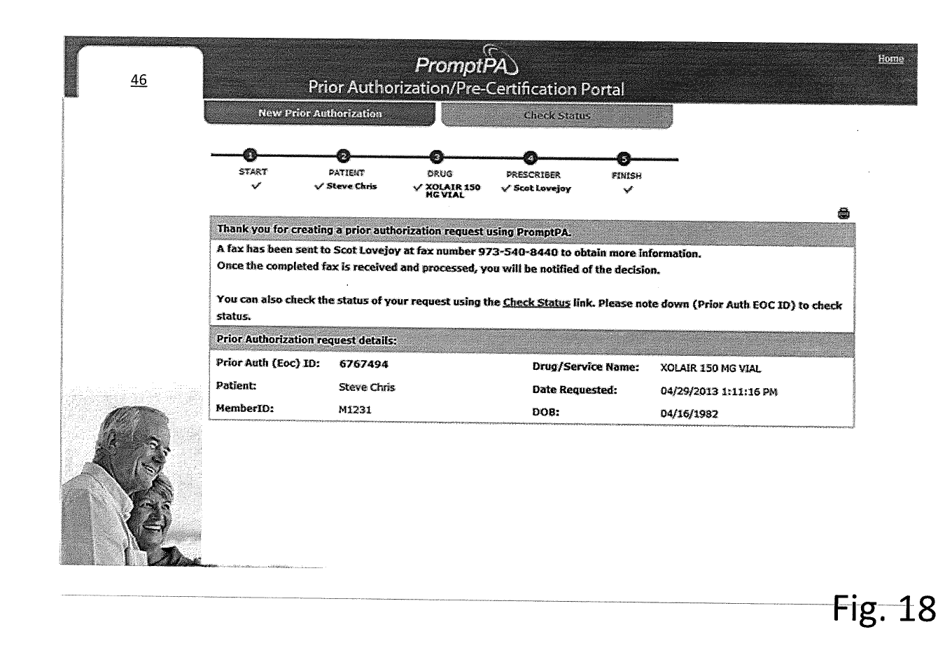

FIG. 18 shows an example UI 46 which displays a confirmation of the PA request to the patient-user. According to an example embodiment, the system generates an identifier code (“Prior Auth EOC ID” in FIG. 18) for the PA request. The identifier code can be displayed, for example, in the confirmation and may be unique to the PA request among all previously initiated PA requests. Alternatively, identifier codes may be recycled so that the code is only unique among all PA requests currently pending in the system or according to a different basis. The identifier code may be used, optionally with additional information about the patient such as the patient's name, date of birth, or member ID, to obtain the status of the PA request from the system. A separate URL can be provided to a web page for checking the status. According to an example embodiment, the identifier code generated for the PA request is required by the system in order to access information regarding the previously input PA request because the system allows access to the system without a formal log-in. Accordingly, the confirmation is required as a security measure to maintain confidentiality.

In an example embodiment, the system stores a plurality of user profiles, e.g., at the server 20, and provides different functionality depending on the user's profile. This is shown in FIG. 2, where the method 200 diverges after step 210 and again after step 220, depending on which user profile was selected, e.g., the patient profile or the prescriber profile.

The system 100 may determine the user's profile at the beginning of the request process, e.g., at step 210. FIG. 19 shows a UI 47 corresponding to step 210, in which the user has identified the user as a prescriber, by selecting the prescriber profile. When the prescriber profile is selected, the answers to the medical necessity questionnaire are expected to be supplied by the user, so it is reasonable to assume that the user has the basic information. Therefore, the system may proceed directly to step 214, omitting step 212 when the user is the prescriber.

Steps 214 to 220 may proceed in a similar fashion as previously described in connection with the patient-user. According to an example embodiment, after identifying the prescriber (at 218) and the provider (at 220), the prescriber-user is directed to the medical necessity questionnaire at step 228. For example, according to an example embodiment, the questionnaire is displayed as an interactive form in the user's web browser, so that the prescriber-user can provide the answers to the questionnaire electronically. The prescriber-user may be given an option to print the questionnaire. This allows the prescriber-user to provide the answers at a later time, e.g., when the answers become available or when the prescriber-user has time to answer all the questions. The printed questionnaire may include instructions on where to send the completed questionnaire, e.g., a fax number or a mailing address for a reviewing entity. Additionally or alternatively, the system is configured for the printed questionnaire to be later scanned and uploaded to the system in connection with the previously initiated PA request.

According to an example embodiment, the system is also configured for a plan sponsor (PS) and/or benefits manager to instantiate a PA request in the system. Therefore, although not shown in the figures, in an example embodiment, a user of the system 100 can include the PS in addition or in alternative to the BM 16. In an example embodiment, to instantiate the PA request, the PS and BM may log into an external system that interfaces with the system that is accessible by the patient/prescriber/provider. Therefore, in contrast to FIG. 1, where the BM 16 is a user of the system 100, the BM 16 may be a user of another system that interfaces with the system 100, e.g., via the communication network 120 or another network that communicates with the server 20.

In an example embodiment where the PS and/or BM instantiate a PA request, a medical necessity questionnaire may be generated, e.g., by the system 100 or by the external system, and transmitted to the provider and/or the prescriber. Transmission may be manually initiated by the PS/BM after instantiating the PA request. Alternatively, transmission may be automatically performed by the system 100. The system 100 provides for the prescriber and/or provider to thereafter submit the completed questionnaire via the system by referring to the instantiated PA request. For example, the system 100 assigns a unique identifier code to the PA request, and the questionnaire is thereafter uploaded to the system 100 by referring to the previously generated identifier code, which may be the same code as previously described in reference to the status inquiry of FIG. 18. According to an example embodiment, the system 100 alerts the prescriber/provider to the presence of the questionnaire, e.g., via an email or a text message containing the identifier code and optionally a link to a webpage at which to input the code. In an example, upon receipt of the identifier code, the system 100 outputs the questionnaire for display on the prescriber/provider's computer device, whereupon the prescriber/provider can complete the questionnaire and save it in completed form on the system (in association with the identifier code). The plan sponsor and/or benefits manager can thereafter use the system to access the completed questionnaire. Similar to the questionnaire generated in response to a prescriber initiated PA request, the system 100 may provide an option to print the questionnaire for hand-writing the answers.

In an example embodiment, PS/BM initiated PA requests may involve fax transmission of the questionnaire to the prescriber/provider. Fax transmission may be initiated in response to the initiation in the system of the PA request by the PS/BM. The prescriber/provider can then complete the faxed questionnaire and send it back for use by the PS/BM or by the system for determining whether to approve the PA request. For example, according to an example embodiment, the system provides for the prescriber/provider to scan and upload to the system the completed questionnaire in association with the identifier code. According to example embodiments, the system may allow for various ways in which the completed questionnaire is provided to the system, including an interactive electronic form, a user uploaded electronic attachment, or a paper fax.

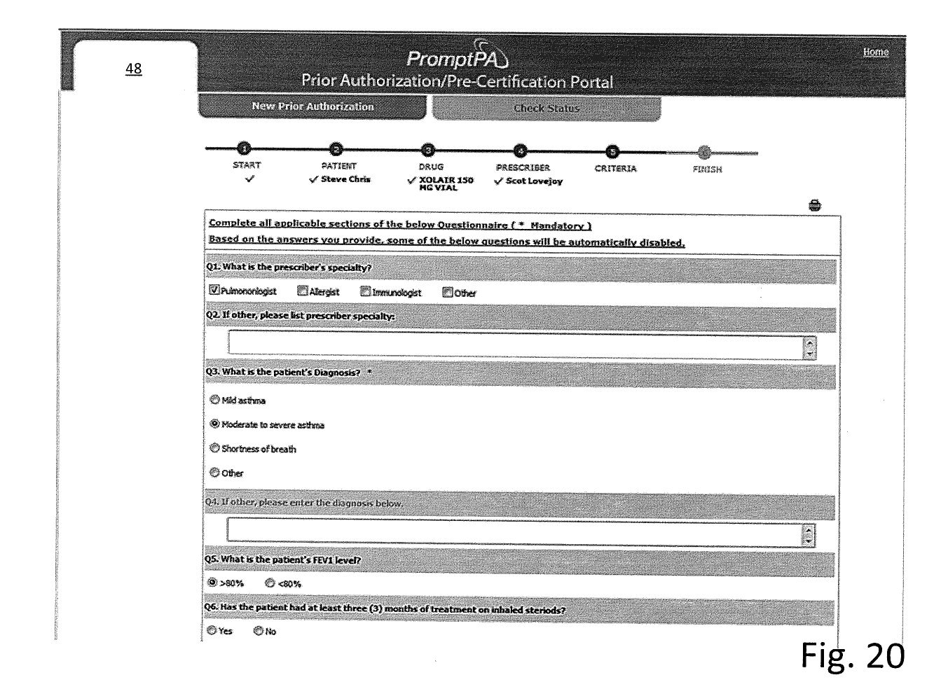

FIG. 20 shows an example UI 48 in which the prescriber-user is asked to provide the prescriber's specialty, the patient's diagnosis, and answers to questions concerning the patient's medical history, which questions may be selected based on the product/service and/or based on the diagnosis. For example, in an example embodiment, the server 20 obtains a set of questions relevant to a drug identified at step 216, e.g., the drug Xolair. In some cases, the question set may be large because the drug can be used to treat a variety of medical conditions. According to an example embodiment, the server 20 is configured to narrow down the number of questions based on additional information from the user. For example, if the diagnosis is asthma, the user may be asked about the patient's forced expiratory volume in 1 second (FEV1) level or whether the patient has previously been treated using inhaled steroids.

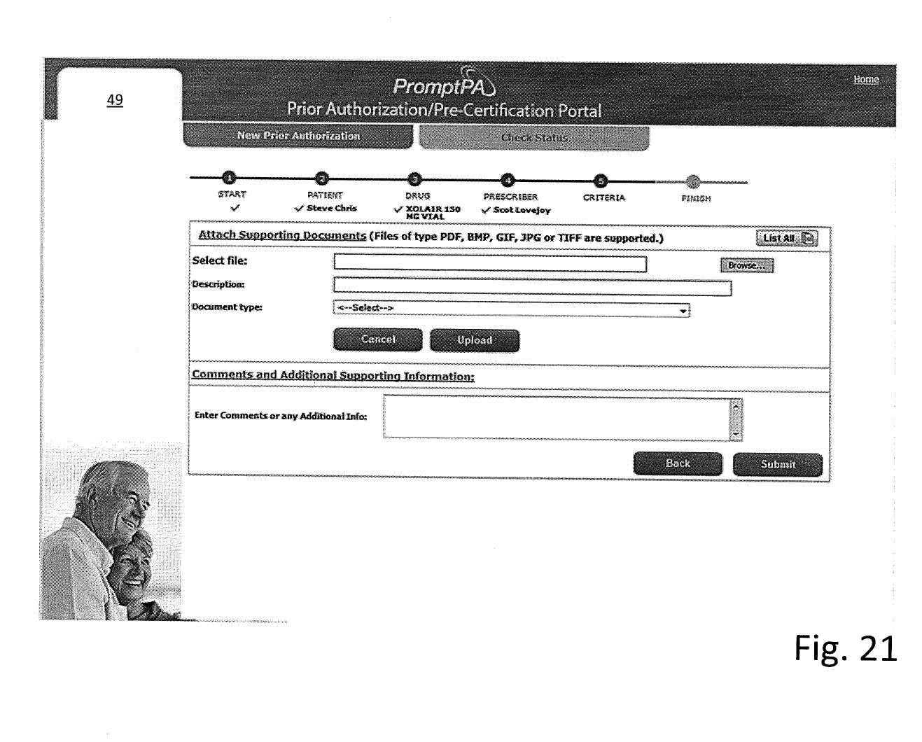

According to an example embodiment, in addition to answering the questionnaire, the system is configured for the prescriber-user to be able to provide supporting documents such as lab reports or medical images. FIG. 21 shows an example UI 49 in which the prescriber-user provides the supporting documents as electronic file attachments, e.g., as a standard image or text file. For example, according to an example embodiment, the UI 49 allows the user to browse the user's computer to select one or more stored files as supporting documents, e.g., by asking the user to identify the document type and then browsing a user specified file directory for all documents of the identified type. According to an example embodiment, the system is configured for the user to input a description of a selected file in addition to comments or other information that may be relevant to the PA request. The supporting documents are, for example, transmittable electronically thorough the UI or faxed. The supporting documents need not be provided at the same time as the answers to the questionnaire. The supporting documents also need not be provided in the same manner as the answers. For example, the prescriber-user may decide that it is more convenient to answer the questionnaire using the UI, but may decide to fax the supporting documents. Therefore, the prescriber-user may initially submit the PA request without providing any supporting documents. In some instances, supporting documents may not even be required for making a decision on the PA request.

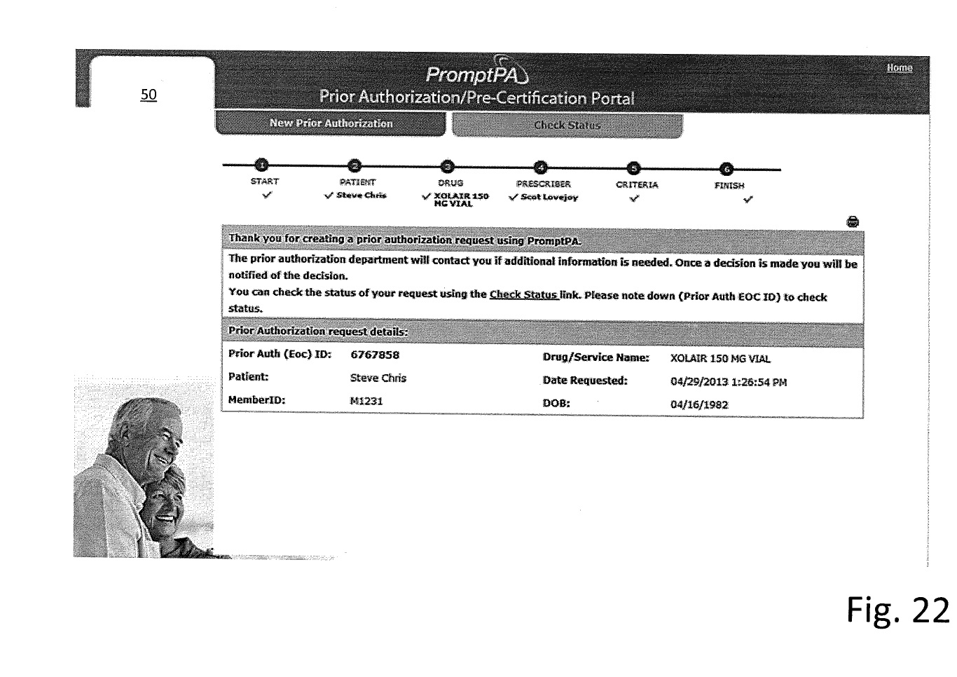

FIG. 2 further shows that, at step 230, the PA request has been successfully initiated and, according to an example embodiment, a confirmation of the PA request is displayed to the prescriber-user. FIG. 22 shows an example UI 50 with a graphical confirmation of a PA request successfully initiated by a prescriber-user according to an example embodiment of the present invention. The information contained in the confirmation may be similar to that of the confirmation for the patient-user in FIG. 18, e.g., including an identifier code that can be used to check the status of the request. However, since the user is the prescriber, a fax has not been sent to the user and therefore the UI 50 may simply indicate that the user may be contacted if additional information is needed to make a decision on the request.

In an example embodiment, the system 100 or the external system is configured to obtain from the plan sponsor and/or benefits manager input of preferences according to which the system is to subsequently interact with a user with regard to a PA request. For example, in an example embodiment, one such preference is whether to transmit the questionnaire as a fax to the prescriber. This allows the PS/BM to, as a security measure, disable electronic display of the questionnaire, which the PS/BM might want because the system 100 does not confirm the identity of the user, and therefore does not guarantee that the user is the prescriber. Accordingly, the system 100 may transmit the questionnaire to the prescriber/provider as a fax, notwithstanding that the user is actually the prescriber. According to an example, the system provides the option to require transmission of the questionnaire as a fax regardless of which user initiated the PA request.

In an example embodiment, the system 100 or the external system is configured to obtain from the plan sponsor and/or benefits manager input of a preference as to whether to receive the completed questionnaire as a fax containing the prescriber's signature. This option is another security measure and may be applied alone or in combination with the option to require fax transmission. For example, the system 100 may allow electronic display of an interactive questionnaire while also requiring the prescriber to return the completed questionnaire by fax. The system 100 may use the answers from the interactive questionnaire to perform preliminary processing of the PA request, which will not be completely processed until the questionnaire is returned by fax.

In an example embodiment, an initial decision on a PA request is performed automatically by computer, e.g., at the server 20, by comparing the relevant criteria from the databases 22 to 26 to the questionnaire answers provided by the prescriber and/or the provider. When the user answers the questionnaire through the UI, the system may have sufficient information to perform the comparison. If the PA request is initiated without providing the answers, the system may postpone the decision until the answers are provided to the server 20. In an example embodiment, answers that are handwritten may be electronically scanned and processed using optical character recognition so that the server 20 can compare the answers to the criteria. Alternatively, handwritten answers may be converted to electronic form using manual data entry.

If the medical information contained in the answers meet the requirements of the criteria, no further processing is required and the confirmation at step 230 may indicate that the request was automatically granted. According to an example embodiment, if the medical information does not meet the criteria, the confirmation may indicate that the request was automatically denied and, in an example, the UI provides the user with an option to initiate an appeal of the denial (e.g., by requesting manual review of the automated decision). In an example embodiment, the confirmation also indicates whether additional information (e.g., supporting documents or answers that have yet to be submitted) or manual review (e.g., review by a health officer or committee, in response to an appeal of a denial or based on the complexity of the request) are required.

As described above, in some instances a decision on the PA request may be automatically performed by the system based on the answers to the medical necessity questionnaire. Additionally, according to an example embodiment, in certain predefined instances, a user input diagnosis, without submission of a completed questionnaire, is sufficient for an automatic and instant approval. Therefore, the system immediately outputs the indication of approval in response to the completed questionnaire or the indicated diagnosis, and further transmits the information to the plan sponsor and/or benefits manager. The system further stores the status, which can be later viewed by input of a generated identification code, as described above. According to the example embodiment in which the system provides for instant approval in response to a predefined diagnosis for a particular requested product or service, in an example, the system skips the steps related to the generation, output, and/or input of a questionnaire once the system receives the input of the relevant diagnosis. The system may perform the decision based on the diagnosis alone, or the diagnosis in combination with additional existing information. This additional information may be stored in the system 100, e.g., in the databases 22/24/26, or in the external system accessed by the PS/BM. A non-exhaustive list of examples of such additional information includes the patient's age, height, weight, gender and previous diagnoses.

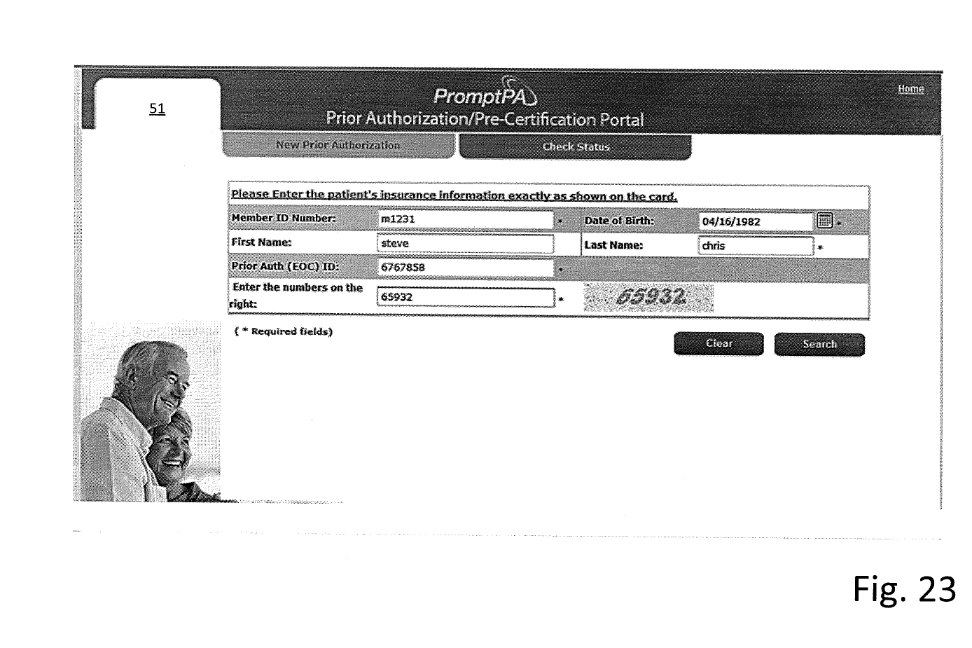

As mentioned earlier, status information may be obtained using an identifier code generated in association with the PA request. For example, FIG. 23 shows an example UI 51 in which the identifier code can be input. Preferably, information in addition to the identifier is required as a condition for accessing the status. This additional information can be the same information requested in step 214 above, e.g., information that is printed on the patient's insurance card or information that is private, but known to users authorized to act on behalf of the patient. For example, similar to the authentication in step 214, the UI 51 may require user input of the patient's member ID, name and/or date of birth. Alternatively, the identifier code alone may be sufficient for requesting the status. The status can be obtained from a record of the PA request stored in the system, e.g., on the server 20.

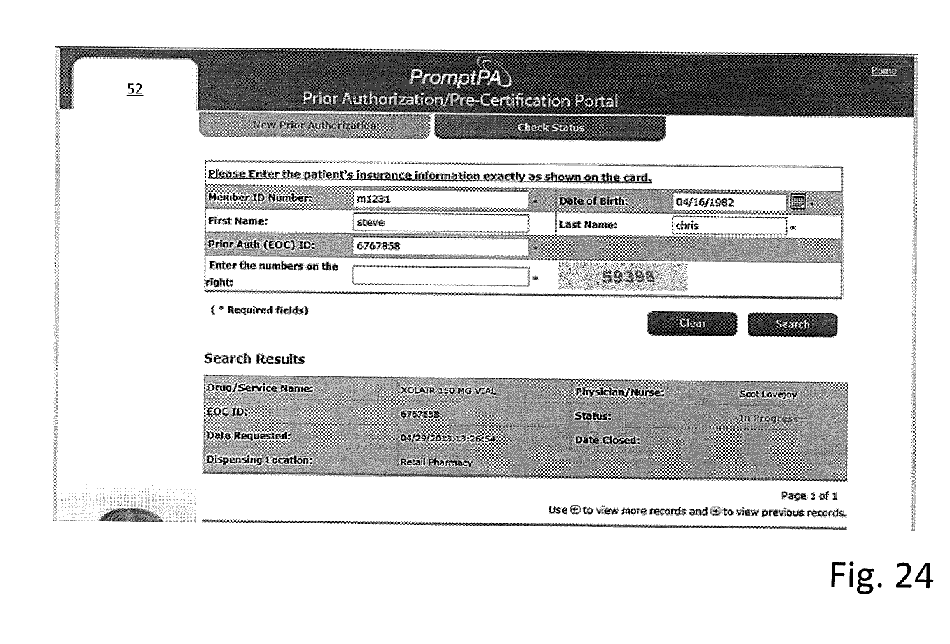

FIG. 24 shows an example embodiment of a UI 52 in which status information is displayed in response to user input of the identifier generated in association with the PA request. The UI 52 shows the product/service requested, the date on which the request was initiated, the name of the prescriber, the location at which the product/service is to be obtained, and the status of the request (e.g., in progress, granted, denied, appeal pending, denied after appeal, etc.).

In an example embodiment, BMs may initiate PA requests in the same manner as the patient-user, by going through the steps 210 to 222 described above. Providers may also initiate requests in a similar manner to the patient-user, except that, according to an example embodiment, the providers are electronically provided with an interactive questionnaire to answer during the same session in which the provider initiates the PA request. In an alternative embodiment, functionality may be provided for BMs and/or providers, which functionality differs from that described above in connection with the patient and the prescriber profiles. For example, when searching for a requested drug, providers may be presented with a list of matching drugs ranked according to the plan sponsor's preferences, which may be stored in the system, e.g., at the server 20 or the databases 22 to 26 (generics and low cost alternatives may be preferred over name brand or expensive drugs).

An example embodiment of the present invention is directed to one or more processors, which can be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination, e.g., to output any one or more of the described graphical user interfaces. The memory device can include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

An example embodiment of the present invention is directed to a non-transitory, hardware computer-readable medium, e.g., as described above, on which are stored instructions executable by a processor to perform any one or more of the methods described herein.

An example embodiment of the present invention is directed to a method, e.g., of a hardware component or machine, of transmitting instructions executable by a processor to perform any one or more of the methods described herein.

Example embodiments of the present invention are directed to one or more of the above-described methods, e.g., computer-implemented methods, alone or in combination.

The above description is intended to be illustrative, and not restrictive. Those skilled in the art can appreciate from the foregoing description that the present invention may be implemented in a variety of forms, and that the various embodiments can be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and appendices. Further, steps illustrated in the flowcharts may be omitted and/or certain step sequences may be altered, and, in certain instances multiple illustrated steps may be simultaneously performed.

What is claimed is:

1. A computer-implemented method for requesting prior authorization for at least one of a medical product and a medical service, comprising:
receiving, by a computer processor, a user selection of one of a plurality of stored user profiles, wherein the stored user profiles include a prescriber profile and a patient profile;
performing, by the processor, a process that includes obtaining information from the user, wherein the process differs depending on which user profile was selected; and
initiating, by the processor, a prior authorization request for the at least one of the medical product and the medical service based on input from the user during the process.

2. The method of claim 1, wherein the stored user profiles further includes a provider user profile.

3. The method of claim 1, wherein irrespective of which user profile was selected, the process includes a request for the user to identify a prescriber of the at least one of the medical product and the medical service.

4. The method of claim 1, wherein irrespective of which user profile was selected, the process includes a request for the user to identify a provider of the at least one of the medical product and the medical service.

5. The method of 1, further comprising:
as a condition for initiating the prior authorization request, authenticating the user by obtaining user input of health plan information associated with a recipient of the at least one of the medical product and the medical service.

6. The method of claim 1, further comprising:
generating, by the processor, an identifier code for the prior authorization request; and
providing, by the processor, the user with a status of the authorization request conditional upon user input of the code.

7. A computer-implemented method for processing prior authorization for at least one of a medical product and a medical service, comprising:
receiving, by a computer processor, user input of a health plan membership identifier associated with a recipient of the at least one of the medical product and the medical service;
selecting, by the processor, a database from a plurality of databases, wherein different ones of the plurality of databases (a) store information pertaining to different respective ones of a plurality of plan sponsors and (d) are associated with different respective sets of health plan membership identifiers;
obtaining, by the processor and based on the input health plan membership identifier, criteria from the selected database; and
determining, by the processor and based on whether medical information pertaining to the recipient meets the criteria, whether to grant the prior authorization request.

8. The method of claim 7, wherein the processor is configured to obtain the criteria even where the recipient's membership identifier is not unique among membership identifiers associated with different ones of the plurality of databases.

9. The method of claim 7, further comprising:
providing a user interface for initiation of the prior authorization request, wherein the user interface is accessible using each of a plurality of Internet addresses, and the database is selected based on which one of the plurality of Internet addresses was used to access the user interface.

10. A computer-implemented method for providing a status of a prior authorization request for at least one of a medical product and a medical service, comprising:
generating, by a computer processor, an identifier code for the prior authorization request; and
without confirming an identity of a user, providing the status of the prior authorization request in response to user input of the identifier code.

11. The method of claim 10, further comprising:
conditioning the providing of the status on user input of a health plan membership identifier associated with a recipient of the at least one of the medical product and the medical service.

12. The method of claim 10, further comprising:
associating the prior authorization request with a completed medical necessity questionnaire that includes answers to questions pertaining to the recipient, wherein the prior authorization request is associated with the completed questionnaire using the identifier code.

13. A computer-implemented method for requesting prior authorization for at least one of a medical product and a medical service, comprising:
generating, by a computer processor, a medical necessity questionnaire including questions pertaining to a recipient of the at least one of the medical product and the medical service, wherein the questions are different depending on which of a plurality of medical products and services is requested; and
executing, by the processor, an algorithm according to which, when the user has been identified as being one of a prescriber and a provider of the at least one of the medical product and the medical service, the processor outputs the questionnaire to the user as an interactive form with answer fields.

14. The method of claim 13, wherein execution of the algorithm causes the processor to perform the following:
where the questionnaire is an interactive form, providing the user with an option to answer the questionnaire electronically and an option to print the questionnaire for handwriting the answers.

15. The method of claim 13, wherein execution of the algorithm causes the processor to perform the following:
where the questionnaire is an interactive form, pre-populating answer fields in the questionnaire with information provided by the user.

16. The method of claim 13, wherein the algorithm is configured to cause the processor to perform the following where the user has been identified as being the recipient:
transmitting the questionnaire to one of a prescriber and a provider using a fax.

17. A computer-implemented method for requesting prior authorization for at least one of a medical product and a medical service, comprising:
receiving, by a computer processor, first user input identifying the at least one of the medical product and the medical service and second user input identifying an intended recipient of the at least one of the medical product and the medical service;
subsequent to the receipt of at least one of the first user input and the second user input, receiving, by the processor, user identification of a prescriber of the at least one of the medical product and the medical service; and
generating the prior authorization request based on the received user input and the user identification.

18. The method of claim 17, further comprising:
outputting a user interface display through which the user inputs a search parameter; and
using the search parameter to search a database for the prescriber.

19. The method of claim 18, further comprising:
providing the user with an option to associate the prescriber with a recipient of the at least one of the medical product and the medical service; and
providing an option to select the associated prescriber without a search during a subsequent prior authorization request for the recipient.

20. A computer-implemented method for requesting prior authorization for at least one of a medical product and a medical service, comprising:
initiating a prior authorization request in response to user input of information pertaining to a recipient of the at least one of the medical product and the medical service;
generating an identifier code for the prior authorization request; and
associating the prior authorization request with a completed medical necessity questionnaire that includes answers to questions pertaining to the recipient, wherein the prior authorization request is associated with the completed questionnaire using the identifier code.
